(19) United States
(12) Patent Application Publication
(10) Pub. No.: US 2004/0103717 A1
(43) Pub. Date: Jun. 3, 2004

(54) Process for the production of polycarbonate which is damaged to a particularly small extent by oxygen

(76) Inventors: Stefan Westernacher, Kempen (DE); Wolfgang Ebert, Krefeld (DE); Klaus Fassbender, Rheinberg (DE); Bernd Willenberg, Bergisch Gladbach (DE); Andreas Frankenau, Kempen (DE); Hermann Kauth, Krefeld (DE); Gary Conklin, Krefeld (DE); Christoph Biedron, Moers (DE); Melanie Mothrath, Dusseldorf (DE); Uwe Hucks, Alpen (DE); Ute Wollborn, Krefeld (DE); Claus-Ludolf Schultz, Krefeld (DE)

Correspondence Address: BAYER POLYMERS LLC, 100 BAYER ROAD, PITTSBURGH, PA, 15205, US

(21) Appl. No.: 10/688,104

(22) Filed: Oct. 17, 2003

(30) Foreign Application Priority Data
Oct. 21, 2002 (DE) 10248950.5
Apr. 1, 2003 (DE) 10314609.1

(51) Int. Cl. G01M 3/20; C08G 64/00; C08G 64/20

(52) U.S. Cl. 73/40.7; 528/196

(57) ABSTRACT

A process for producing polycarbonate is disclosed. The process entails using equipment having leakage rate less than 10⁻³ liter He×mbar/sec. The polycarbonate thus produced is characterized by its enhanced thermal stability.

### FIELD OF THE INVENTION

The invention relates to polycarbonate resins and in particular to a process for making such resins.

### SUMMARY OF THE INVENTION

A process for the preparation of polycarbonate is disclosed. The process that entails polycondensation reaction is carried out in an apparatus having a leakage rate of <10⁻³ liters He×mbar/s. The polycarbonate thus produced is characterized by its enhanced thermal stability.

### BACKGROUND OF THE INVENTION

Polycarbonate is very often exposed as a melt in some cases to extreme temperatures for evaporation of the solvent or for transesterification purposes (>200° C.). The presence of oxygen here leads to lasting damage to the polycarbonate.

Polycarbonate that is produced by the phase interface process is subjected in some cases to extreme temperatures (>200° C.) in order to evaporate the solvent. The presence of oxygen leads in this connection to permanent damage of the polycarbonate.

In previous specifications only the reduction of the oxygen content in the bisphenolate solution (DE-A 1 99 43 643, DE-A 1 99 43 644, WO-A 2000/39060) and the contact of bisphenol melt with oxygen (JP-A 06025044, JP-A 06025045) were described, and their positive influence on the color quality of the polycarbonate has been emphasized. Furthermore the addition of nitrogen in the extrusion of polycarbonate melt has been described (JP-A 08132437). In the processes according to the prior art the polycarbonate is nevertheless still damaged.

Polycarbonate that is produced by the melt transesterification process is as melt subjected in some cases to extreme temperatures (>270° C.) at absolute pressures down to 0.01 mbar during the course of the reaction. The presence of oxygen similarly leads to a permanent damage of the polycarbonate.

In previous specifications the reduction of the contact of the educts with oxygen during mixing and melting (JP-A 6 032 887, JP-A 8 157 588), the reduction of the contact of BPA with oxygen during melting (JP-A 8 157 587) as well as the reduction of the contact of the diphenyl carbonate melt with oxygen (JP-A 3216832) have been described and the positive effect on the color quality of the polycarbonate has been emphasized. In the processes according to the prior art the polycarbonate is nevertheless still damaged.

In EP-A 708 128 a melt transesterification process for polycarbonate in an inert, low oxygen content gaseous atmosphere is described. The first half of the reaction is preferably carried out without application of a vacuum under cleavage of phenol in a reactor space that is permanently flushed with an inert, possibly pretreated gas with a low oxygen content (at least <2 ppm). The end phase of the reaction is carried out with an increase in the vacuum. The execution of this process under exclusion of oxygen however proves to be extremely disadvantageous and undesirable in large-scale production. A circulation of the inert gas streams is therefore advantageous for the economy of a continuous process. If these streams are to be recycled they have to be freed from phenol however, which is extremely complicated. A preferred further pretreatment of the inert gas for additional reduction of the oxygen content furthermore makes the method even more cost-intensive.

On the basis of the prior art there was therefore a need to develop a process that permits the largely damage-free production or processing of polycarbonate in a comparatively more simple and cost-effective procedure.

### BRIEF DESCRIPTION OF THE FIGURE

FIG. 1 describes the relationship between the color index and the CO₂ cleavage as a function of the O₂ absorption.

### DETAILED DESCRIPTION OF THE INVENTION

It has now surprisingly been found that it is sufficient that the apparatus in which the polycarbonate melt is produced or processed has a leakage rate of <10⁻³ liter He×mbar/sec. Ideally all vessels, apparatus, pumps and pipelines that are used in the production and/or processing of polycarbonate, but at the very least the apparatus in which reduced pressure (<1 bar absolute) is applied, such as for example large capacity vessels, pipelines, separators or cyclones; stirred vessels, forced circulation evaporators, falling-film evaporators, pipe/strand evaporators, single-shaft or twin-shaft cage reactors or disc reactors, or other commercially obtainable apparatus as well as associated vacuum equipment and vapor systems, vaporization extruders, pipe/strand evaporators and injection molding machines and extruders, will meet this requirement.

The invention accordingly provides a process for the production or processing of polycarbonate using equipment and apparatus in which the leakage rate is <10⁻³ liter He×mbar/sec, preferably <10⁻⁴ liter He×mbar/sec, particularly preferably <10⁻⁵ liter He×mbar/sec, and most particularly preferably <10⁻⁶ liter He×mbar/sec.

The leakage rates are measured for example by connecting a helium gas measuring instrument from Leybold, type 100, 100 plus or 200 or comparable equipment to the vapor inlets of a plant for the production or processing of polycarbonate, optionally with an intermediate preliminary pump, which optionally leads only a part stream of the amount of gas to the meter. The flanges of the whole arrangement, which is under reduced pressure, are flushed with helium gas from a gas cylinder, using a gas lance. The measuring instrument measures the amount of helium that is drawn in through the flanges and indicates a leakage rate. In this connection a leakage rate of <10⁻³ liter He×mbar/sec is counted as tight, and a leakage rate >10⁻³ liter He×mbar/sec is counted as a leak. Measurements on a test leak may optionally be carried out before performing the actual measurement. In addition it is recommended to determine the baseline concentration of helium in the ambient atmosphere by means of the measuring instrument. This concentration is then used as a zero value or reference value. Leaks in the flange connections may also be found by means of ultrasound and using leak spray, though in this case the detection limit is 10⁻² liter He×mbar/sec and is thus less sensitive than the described helium leakage test.

The helium leakage test is first of all carried out when the system is cold. The system is then heated to the desired operating temperatures and all flanges are tightened before repeating the leakage test. Only if this leakage test gives a positive result does the system satisfy the requirements.

The polycarbonate produced in this way is characterized by an improved color quality and is also the subject of the present invention.

The particular advantage of this process is that the hermeticity of the apparatus may easily be tested by means of a helium leakage test and thus, surprisingly, displacement gases for oxygen, such as for example nitrogen, and the associated equipment are not necessary.

The polycarbonate is produced for example by the phase interface process. This process for the polycarbonate synthesis is described in many places in the literature, including inter alia in

Schnell, “Chemistry and Physics of Polycarbonates”, Polymer Reviews, Volume 9, Interscience Publishers, New York, London, Sydney 1964, p. 33-70;

D. C. Prevorsek, B. T. Debona and Y. Kesten, Corporate Research Center, Allied Chemical Corporation, Morristown, N.J. 07960: “Synthesis of Poly(ester Carbonate) Copolymers” in Journal of Polymer Science, Polymer Chemistry Edition, Vol. 18, (1980), pp. 75-90,

D. Freitag, U. Grigo, P. R. Müller, N. Nouvertne', BAYER AG, “Polycarbonates” in Encyclopedia of Polymer Science and Engineering, Volume 11, 2^{nd} Edition, 1988, pp. 651-692, and finally

Dres. U. Grigo, K. Kircher and P. R. Müller “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, pp. 118-145,

as well as for example in EP-A 0 517 044 and many other patent applications. According to this process the phosgenation of a disodium salt of a bisphenol (or a mixture of different bisphenols) in aqueous-alkaline solution (or suspension) is carried out in the presence of an inert organic solvent or solvent mixture, which forms a second phase. The oligocarbonates that are formed and that are mainly present in the organic phase are condensed with the aid of suitable catalysts to form high molecular weight polycarbonates that are dissolved in the organic phase. The organic phase is finally separated and the polycarbonate is isolated by various working-up steps.

In this process an aqueous phase containing NaOH, one or more bisphenols and water is used, wherein the concentration of bisphenol of this aqueous solution with respect to the sum total of bisphenols, calculated not as sodium salt but as free bisphenol, may vary between 1 and 30 wt. %, preferably between 3 and 25 wt. %, particularly preferably between 3 and 8 wt. % for polycarbonates with an M_{w}>45,000, and 12 to 22 wt. % for polycarbonates with an M_{w}<45,000. Weight % here means relative to the weight of the aqeous phase. In this connection it may be necessary in the case of higher concentrations to thermostatically control the solutions. The sodium hydroxide used to dissolve the bisphenols may be employed in solid form or as aqueous sodium hydroxide solution. The concentration of the sodium hydroxide solution is governed by the target concentration of the desired bisphenolate solution, but as a rule is between 5 and 25 wt. %, preferably between 5 and 10 wt. %, or may be chosen to be more concentrated, in which case it is then diluted with water. In the process involving subsequent dilution sodium hydroxide solutions with concentrations between 15 and 75 wt. %, preferably between 25 and 55 wt. %, optionally heated, are used. Here wt % means relative to the weight of the sodium hydroxide solution. The alkali content per mole of bisphenol depends very largely on the type of the bisphenol and varies between 0.25 and 5.00 mole of alkali per mole of bisphenol, preferably 1.5-2.5 mole of alkali per mole of bisphenol; in the case where bisphenol A is used as sole bisphenol, the alkali content is 1.85-2.15 mole of alkali per mole of bisphenol A. If more than one bisphenol is used, then these may be dissolved together. It may however also be advantageous to dissolve the bisphenols separately in an optimal alkaline phase and to meter in the solutions separately or alternatively to add them combined to the reaction. In addition it may be advantageous to dissolve the bisphenol or bisphenols not in sodium hydroxide solution but in dilute bisphenolate solution to which additional alkali has been added. The dissolution processes may start from solid bisphenol, generally in flakes or prill form, or also from molten bisphenol. The sodium hydroxide or sodium hydroxide solution that is used may be produced by the amalgam process or the so-called membrane process. Both processes have been in use for a long time and are known to the person skilled in the art. Sodium hydroxide produced by the membrane process is preferably employed.

The thus prepared aqueous phase is phosgenated together with an organic phase contains solvents for polycarbonate that are inert to the reactants and that form a second phase.

The optionally employed metering of bisphenol after or during the addition of the phosgene may be continued as long as phosgene or its immediate secondary products, namely chlorinated carbonic acid esters, are present in the reaction solution.

The synthesis of polycarbonates from bisphenols and phosgene in an alkaline medium is an exothermic reaction and is carried out in a temperature range from −5° C. to 100° C., preferably 15° C. to 80° C., most particularly preferably 25° C. to 65° C., wherein the reaction possibly has to be carried out under excess pressure depending on the solvent or solvent mixture.

Suitable diphenols for the production of the polycarbonates to be used according to the invention include for example hydroquinone, resorcinol, dihydroxy-diphenyl, bis-(hydroxyphenyl)alkanes, bis-(hydroxyphenyl)cycloalkanes, bis-(hydroxyphenyl)sulfides, bis-(hydroxyphenyl)ethers, bis-(hydroxyphenyl)ketones, bis-(hydroxyphenyl)sulfones, bis-(hydroxyphenyl)sulfoxides, (α,α′-bis-(hydroxyphenyl)diisopropylbenzenes, as well as their alkylated, nuclear-alkylated and nuclear-halogenated compounds.

Preferred diphenols are 4,4′-dihydroxydiphenyl, 2,2-bis-(4-hydroxyphenyl)-1-phenylpropane, 1,1-bis-(4-hydroxyphenyl)phenylethane, 2,2-bis-(4-hydro-xyphenyl)-propane, 2,4-bis-(4-hydroxyphenyl)-2-methylbutane, 1,1-bis-(4-hydroxyphenyl)-m/p-diisopropylbenzene, 2,2-bis-(3-methyl-4-hydroxyphenyl)propane, bis-(3,5-dimethyl-4-hydroxyphenyl)methane, 2,2-bis-(3,5-dimethyl-4-hydroxyphenyl)propane, bis-(3,5-dimethyl-4-hydroxyphenyl)sulfone, 2,4-bis-(3,5-dimethyl-4-hydroxyphenyl)-2-methyl-butane, 1,1-bis-(3,5-dimethyl-4-hydroxyphenyl)-m/p-diisopropylbenzene and 1,1-bis-(4-hydroxyphenyl)-3,3,5-trimethylcyclohexane.

Particularly preferred diphenols are 4,4′-dihydroxydiphenyl, 1,1-bis-(4-hydroxyphenyl)-phenylethane, 2,2-bis-(4-hydroxyphenyl)propane, 2,2-bis-(3,5-dimethyl-4-hydroxy-phenyl)propane, 1,1-bis-(4-hydroxyp 1,1-bis-(4-hydroxy-phenyl)-3,3,5-trimethylcyclohexane.

These and further suitable diphenols are described for example in U.S. Pat. Nos. 2,999,835, 3,148,172, 2,991,273, 3,271,367, 4,982,014 and 2,999,846, in German laid-open specifications 1 570 703, 2 063 050, 2 036 052, 2 211 956 and 3 832 396, in French patent specification 1 561 518, in the monograph by H. Schnell “Chemistry and Physics of Polycarbonates”, Interscience Publishers, New York 1964, pp. 28 ff.; pp. 102 ff., and in D. G. Legrand, J. T. Bendler, “Handbook of Polycarbonate Science and Technology”, Marcel Dekker, New York 2000, pp. 72 ff. all incorporated herein by reference.

In the case of homopolycarbonates only one diphenol is used, while in the case of copolycarbonates several diphenols are used, in which connection the bisphenols that are used as well as all other chemicals and auxiliary substances added to the synthesis may obviously be contaminated with impurities originating from their actual synthesis, handling and storage, although it is desirable to use raw materials that are as clean as possible.

The organic phase may consist of one solvent or mixtures of several solvents. Suitable solvents include chlorinated hydrocarbons (aliphatic and/or aromatic), preferably dichloromethane, trichlorethylene, 1,1,1-trichloroethane, 1,1,2-trichloroethane and chlorobenzene and their mixtures. Aromatic hydrocarbons such as benzene, toluene, m/p/o-xylene or aromatic ethers such as anisole may however also be used, alone, as a mixture, or additionally as a mixture with chlorinated hydrocarbons. Another embodiment of the synthesis uses solvents that do not dissolve but only swell polycarbonate. Accordingly precipitation agents for polycarbonate may also be used in combination with solvents for polycarbonate. In this case solvents such as tetrahydrofuran, 1,3-/1,4-dioxane or 1,3-dioxolane that are also soluble in the aqueous phase may then be used as solvents if the solvent partner forms the second organic phase.

The two phases forming the reaction mixture are mixed in order to accelerate the reaction. This is effected by supplying energy via shear forces, i.e. pumps or stirrers or by static mixers, or by generating turbulent flow by means of nozzles and/or diaphragms. Combinations of these measures are also employed, often also repeated over time or as regards sequence of equipment. Anchor, propeller, MIG stirrers, etc., such as are described for example in Ullmann “Encyclopedia of Industrial Chemistry”, 5^{th} Edition, Vol. B2, pp. 251 ff are preferably used as stirrers. Centrifugal pumps, often also multi-stage pumps are employed as pumps, 2- to 9-stage pumps being preferred. Nozzles and/or baffles which are employed are perforated baffles and pieces of pipe narrowed at the position thereof, or also Venturi or Lefos nozzles.

The phosgene may be added in gaseous or liquid form or dissolved in solvents. The phosgene excess that is employed, referred to the sum total of the bisphenols used, is between 3 and 100 mole %, preferably between 5 and 50 mole %. In this connection the pH value of the aqueous phase during and after addition of phosgene is maintained in the alkaline range, preferably between 8.5 and 12, by single or repeated additional metering in of sodium hydroxide solution or appropriate additional metering in of bisphenolate solution, whereas after the addition of catalyst the pH should be between 10 and 14. The temperature during the phosgenation is 25° to 85° C., preferably 35° to 65° C.; the phosgenation may also be carried out under excess pressure depending on the solvent that is used.

The phosgene may be metered directly into the aforedescribed mixture of the organic and aqueous phase or however may also be wholly or partially metered, before the mixing of the phases, into one of the two phases, which is then mixed with the corresponding other phase. It is furthermore possible to meter all or some of the phosgene into a part stream taken from the main stream of the synthesis mixture of the two phases, this phosgene loaded part stream preferably being recycled before the addition of the catalyst. In another embodiment the aforedescribed aqueous phase is mixed with the phosgene-containing organic phase and is then added after a residence time of 1 second to 5 minutes, preferably 3 seconds to 2 minutes, to the recycled partial stream mentioned above, or alternatively the two phases, namely the aforedescribed aqueous phase together with the phosgene-containing organic phase, are mixed directly in the recycled partial stream mentioned above. In all these embodiments the aforedescribed pH ranges should be observed and if necessary maintained by single or repeated additional metering in of sodium hydroxide solution or appropriate additional metering in of bisphenolate solution. Also, the temperature range must be maintained, if necessary by cooling or dilution.

The polycarbonate synthesis may be effected continuously or discontinuously. The reaction may accordingly take place in stirred vessels, tubular reactors, pump reactors or stirred vessel cascades or combinations thereof, in which connection it should be ensured by employing the already mentioned mixing devices that, as far as possible, the aqueous and organic phases demix only when the synthesis mixture has fully reacted, i.e. no longer contains saponifiable chlorine from phosgene or chlorinated carbonic acid esters.

The monofunctional chain terminators required to regulate the molecular weight, such as phenol or alkylphenols, in particular phenol, p-tert.-butylphenol, isooctylphenol, cumylphenol, their chlorinated carbonic acid esters or acid chlorides of monocarboxylic acids or mixtures of these chain terminators, are added either together with the bisphenolate or bisphenolates to the reaction, or alternatively are added at any appropriate time during the synthesis as long as phosgene or chlorinated carbonic acid terminal groups are still present in the reaction mixture, or in the case where acid chlorides and chlorinated carbonic acid esters are used as chain terminators, as long as sufficient phenolic terminal groups of the polymer that is being formed are available. Preferably the chain terminator or terminators are however added after the phosgenation at a site or at a time when phosgene is no longer present but the catalyst has not yet been added, or are added before the catalyst, together with the catalyst, or concurrently therewith.

In the same way branching agents or branching agent mixtures that may be used are added to the synthesis, normally however before the chain terminators. Trisphenols, quaternary phenols or acid chlorides of tricarboxylic acids or tetracarboxylic acids are normally used, but also mixtures of the polyphenols or acid chlorides.

Some of the compounds containing three or more phenolic hydroxyl groups that may be used include for example:

phloroglucinol,

4,6-dimethyl-2,4,6-tri-(4-hydroxyphenyl)heptene-2,

4,6-dimethyl-2,4,6-tri-(4-hydroxyphenyl)heptane,

1,3,5-tri-(4-hydroxyphenyl)benzene,

1,1,1-tri-(4-hydroxyphenyl)ethane,

tri-(4-hydroxyphenyl)phenylmethane,

2,2-bis-[4,4-bis-(4-hydroxyphenyl)cyclohexyl]propane,

2,4-bis-(4-hydroxyphenylisopropyl)phenol,

tetra-(4-hydroxyphenyl)methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole,

Preferred branching agents are 3,3-bis-(3-methyl-4-hydroxyphenyl)-2-oxo-2,3-dihydroindole and 1,1,1-tri-(4-hydroxyphenyl)ethane.

The catalysts used in the phase interface synthesis include tertiary amines, in particular triethylamine, tributylamine, trioctylamine, N-ethylpiperidine, N-methylpiperidine, N-i/n-propylpiperidine; quaternary ammonium salts such as tetrabutylammonium/tributylbenzylammonium/tetraethylammonium hydroxide/chloride/bromide/hydrogen sulfate/tetrafluoroborate, as well as the phosphonium compounds corresponding to the ammonium compounds. In this context ammonium and phosphonium compounds are also jointly referred to as onium compounds.

These compounds are described as typical phase interface catalysts in the literature, are commercially available, and are known to the person skilled in the art. The catalysts may be added individually, as a mixture, or also together and in succession to the synthesis. They are optionally also added before the phosgenation, though addition after the introduction of the phosgene is preferred irrespective of whether one onium compound or mixtures of onium compounds are used as catalysts, in which case an addition before the metering of the phosgene is preferred.

The metering in of the catalyst or catalysts may take place without solvent, in an inert solvent, preferably that used for the polycarbonate synthesis, or also as an aqueous solution, and in the case of tertiary amines as their ammonium salts with acids, preferably mineral acids, in particular hydrochloric acid. When using several catalysts or when the total amounts of catalyst are metered in portions, different metering procedures may of course also be used at different sites or at different times.

The total amount of the catalysts that are used is between 0.001 to 10 mole % referred to moles of bisphenols employed, and is preferably 0.01 to 8 mole %, particularly preferably 0.05 to 5 mole %.

After addition of the phosgene it may be advantageous to mix the organic phase and the aqueous phase for a certain time, before optionally branching agent (where this is not metered in jointly with the bisphenolate), chain terminator and catalyst are added. Such a subsequent stirring time may be advantageous after each addition. These subsequent stirring times, insofar as they are employed, are between 10 seconds and 60 minutes, preferably between 30 seconds and 40 minutes and particularly preferably between 1 minute and 15 minutes.

The reaction mixture that contains at least two phases that has fully reacted and contains at most only traces (preferably <2 ppm) of chlorinated carbonic acid esters, is allowed to settle before the phase separation. The aqueous alkaline phase is if necessary recycled in whole or in part to the polycarbonate synthesis as aqueous phase, or is added to the waste water treatment stage, where solvent and catalyst fractions are separated and recycled. In another variant of the working-up process, after separating the organic impurities, in particular solvents and polymer residues, and optionally after adjusting a specific pH value, for example by addition of sodium hydroxide, the salt is separated, which may be fed for example to a chlorine-alkali electrolysis plant, while the aqueous phase is optionally recycled to the synthesis.

The organic phase containing the polymer now only has to be purified to remove all contaminants of an alkaline, ionic or catalytic nature. After one or more settling operations, some of the aqueous alkaline phase is still present in fine droplets as well as the catalyst, generally a tertiary amine, The settling may be carried out by flowing through at least one appropriate apparatus selected from among settling tanks, stirred tanks, coalescers and separators or combinations of these. Water may be metered in during each or some of these separators. Mixing means including active and/or passive kinds of may be used as well.

After this coarse separation of the alkaline aqueous phase the organic phase is washed once or several times with dilute acids, i.e. mineral, carboxylic, hydrocarboxylic and/or sulfonic acids. Aqueous mineral acids are preferred, in particular hydrochloric acid, phosphorous acid and phosphoric acid, or mixtures of these acids. The concentration of these acids should be in the range from 0.001 to 50 wt. %, preferably 0.01 to 5 wt. %.

In addition the organic phase is repeatedly washed with demonized or distilled water. The separation of the organic phase, optionally dispersed with portions of the aqueous phase, is carried out after the individual wash stages by means of settling tanks, stirred vessels, coalescers or separators or combinations of these measures, in which connection the wash water may optionally be added between the wash stages, optionally using active or passive mixing equipment.

Acids, preferably dissolved in the solvent used for the polymer solution, may optionally be added between these wash stages or also after the wash process. Gaseous hydrogen chloride and phosphoric acid or phosphorous acid are preferred in this connection, and may optionally also be employed as mixtures.

The purified polymer solution thereby obtained should after the last separation process contain not more than 5 wt. %, preferably less than 1 wt. %, and most particularly preferably less than 0.5 wt. % of water.

The polymer may be isolated from the solution by evaporating the solvent by means of heat, vacuum or a heated entrainment gas. Other isolating methods include crystallization and precipitation.

The concentration of the polymer solution and possibly also isolation of the polymer may be carried out by the “flash process” This process that entails distilling of the solvent, optionally by superheating and letting down, has been disclosed for example in “Thermische Trennverfahren”, VCH Verlagsanstalt 1988, p. 114.

Alternatively the concentration may be carried out by “spray evaporation/spray drying” whereby a heated carrier gas is sprayed together with the solution to be evaporated. This process has been disclosed among others by Vauck in “Grundoperationen chemischer Verfahrenstechnik”, Deutscher Verlag für Grundstoffindustrie 2000, 11th edition, p. 690. All these processes are described in the patent literature and in text books and are familiar to the expert.

When removing the solvent by heat (distillation) or the technically more effective flash process, highly concentrated polymer melts are obtained. In the known flash process polymer solutions are repeatedly heated under slight excess pressure to temperatures above the boiling point under normal pressure, and these solutions, superheated with respect to normal pressure, are then flashed in a vessel at a lower pressure, for example normal atmospheric pressure. It may be of advantage here not to allow the concentration step, or in other words the temperature in the superheating step, to become too high, but rather to choose a two- to four-step process.

The residues of the solvent may be removed from the highly concentrated polymer melts that are thereby obtained, either directly from the melt using evaporation extruders (BE-A 866 991, EP-A 0 411 510, U.S. Pat. No. 4,980,105, DE-A 33 32 065), thin-layer evaporators (EP-A 0 267 025), falling-film evaporators, strand evaporators, or by friction compaction (EP-A 0 460 450), optionally also under the addition of an entrainment agent such as nitrogen or carbon dioxide or by employing a vacuum (EP-A 0 039 96, EP-A 0 256 003, U.S. Pat. No. 4,423,207) or alternatively by subsequent crystallization (DE-A 34 29 960) and heating of the solvent residues in the solid phase (U.S. Pat. No. 3,986,269, DE-A 20 53 876).

Granules are obtained preferably by direct spinning of the melt and subsequent granulation, or by the use of discharge extruders from which the granules are spun in air or under a liquid, generally water. If extruders are used, additives may be added to the melt by conventional means.

By means of an atomization procedure the polymer solution, optionally after heating, is sprayed either into a vessel at reduced pressure or is sprayed by means of a nozzle using a heated carrier gas, for example nitrogen, argon or steam, into a vessel at normal atmospheric pressure. In both cases, depending on the concentration of the polymer solution, powder (diluted) or flakes (concentrated) of the polymer are obtained, from which if necessary the last residues of the solvent also have to be removed, as described above. Granules may then be obtained using a compounding extruder followed by spinning. Here too additives, as described above, may be added to the peripheral equipment or to the extruder itself. A compacting step for the polymer powder often has to be employed before the extrusion on account of the low bulk density of the powders and flakes.

The polymer may be precipitated largely in crystalline form from the washed and optionally also concentrated solution of the polycarbonate by adding a precipitating agent for polycarbonate. In this connection it is advantageous to add first a minor amount of the precipitating agent and optionally also add the precipitating agent discontinuously. It may also be advantageous to use different precipitating agents. Hydrocarbons, in particular heptene, i-octane, cyclohexane and alcohols such as methanol, ethanol and i-propanol may for example be used in this connection as precipitating agents.

In the precipitation the polymer solution is as a rule slowly added to a precipitating agent, alcohols such as methanol, ethanol, i-propanol but also cyclohexane or ketones such as acetone generally being used here as precipitating agents.

The materials obtained in this way are processed to granules, as described in the spray evaporation, and additives are optionally added.

According to other processes, precipitation and crystallization products or amorphously solidified products are crystallized in a fine-grained form by passing over vapors of one or more non-solvents for polycarbonate, with simultaneous heating below the glass transition temperature, and are subjected to further condensation to yield higher molecular weights. If these products are oligomers, possibly with different terminal groups (phenolic and chain-terminating groups), this is referred to as solid phase condensation.

In addition the polycarbonate may be produced according to the invention also by the melt transesterification process. The production of aromatic oligocarbonates and polycarbonates by the melt transesterification process is known in the literature and is described for example in the Encyclopedia of Polymer Science, Vol. 10 (1969), Chemistry and Physics of Polycarbonates, Polymer Reviews, H. Schnell, Vol. 9, John Wiley and Sons, Inc. (1964) as well as in DE-C 10 31 512, U.S. Pat. 3,022,272, U.S. Pat. 5,340,905 and U.S. Pat. 5,399,659.

According to this process aromatic dihydroxy compounds are transesterified with carbonic acid diesters in the melt, with the aid of suitable catalysts and optionally further additives.

Suitable dihydroxyaryl compounds for the process according to the invention are those of the Formula (I)

HO-Z-OH (I)

wherein Z is an aromatic group having 6 to 30 C atoms, which may contain one or more aromatic nuclei, may be substituted and may contain aliphatic or cycloaliphatic groups or alkylaryls or heteroatoms as bridging members. Examples of dihydroxyaryl compounds of the formula (I) include 4,4′-dihydroxydiphenyl, 2,2-bis-(4-hydroxyphenyl)-1-phenylpropane, 1,1-bis-(4-hydroxyphenyl)-phenylethane, 2,2-bis-(4-hydroxyphenyl)propane, 2,4-bis-(4-hydroxyphenyl)-2-methylbutane, 1,3-bis-[2-(4-hydroxyphenyl)-2-propyl]benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)propane, bis-(3,5-dimethyl-4-hydroxyphenyl)-sulfone, 2,4-bis-(3,5-dimethyl-4-hydroxyphenyl)-2-methylbutane, 1,3-bis-[2-(3,5-dimethyl-4-hydroxyphenyl)-2-propyl]benzene and 1,1-bis-(4-hydroxyphenyl)-3,3,5-trimethylcyclohexane (bisphenol TMC).

Particularly preferred diphenols are 4,4′-dihydroxydiphenyl, 1,1-bis-(4-hydroxyphenyl)phenylethane, 2,2-bis-(4-hydroxyphenyl)propane, 2,2-bis(3,5-dimethyl-4-hydroxyphenyl)propane, 1,1-bis-(4-hydroxyphenyl)cyclohexane and 1,1-bis-(4-hydroxyphenyl)-3,3,5-trimethylcyclohexane (bisphenol TMC).

These and further suitable diphenols are described for example in U.S. Pat. Nos. 2,999,835, 3,148,172, 2,991,273, 3,271,367, 4,982,014 and 2,999,846, in German laid-open specifications 1 570 703, 2 063 050, 2 036 052, 2 211 956 and 3 832 396, in French patent specification 1 561 518, in the monograph by H Schnell “Chemistry and Physics of Polycarbonates”, Interscience Publishers, New York 1964, pp. 28ff, pp.102ff, and in D. G. Legrand, J. T. Bendler, “Handbook of Polycarbonate Science and Technology”, Marcel Dekker New York 2000, pp. 72ff. all incorporated herein by reference.

In the case of homopolycarbonates only one diphenol is used, while in the case of copolycarbonates several diphenols are used, in which connection the bisphenols that are used as well as all other chemicals and auxiliary substances added to the synthesis may obviously be contaminated with impurities originating from their actual synthesis, handling and storage, although it is desirable to use raw materials that are as clean as possible.

The dihydroxyaryl compounds may also be used containing residual amounts of the monohydroxyaryl compounds from which they have been prepared. These amounts may be up to 20%, preferably 10%, particularly preferably up to 5% and most particularly preferably up to 2% (see for example EP-A 1 240 232). Carbonic acid diesters within the context of the invention are those of the formulae (II) and (III)

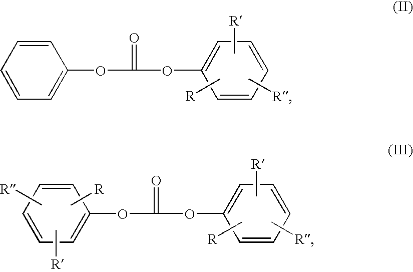

wherein

R, R′ and R″, independently of one another, denote H, optionally branched C₁-C₃₄-alkyl/cycloalkyl, C₇-C₃₄-alkylaryl or C₆-C₃₄-aryl,

for example:

diphenyl carbonate, butylphenyl phenyl carbonate, dibutyl phenyl carbonate, isobutylphenyl phenyl carbonate, diisobutyl phenyl carbonate, tert.butylphenyl phenyl carbonate, ditert.butyl phenyl carbonate, n-pentylphenyl phenyl carbonate, di(n-pentylphenyl) carbonate, n-hexylphenyl phenyl carbonate, di(n-hexylphenyl) carbonate, cyclohexylphenyl phenyl carbonate, dicyclohexyl phenyl carbonate, biphenyl phenyl carbonate, dibiphenyl carbonate, isooctylphenyl phenyl carbonate, diisooctyl phenyl carbonate, n-nonylphenyl phenyl carbonate, di(n-nonylphenyl) carbonate, cumylphenyl phenyl carbonate, dicumyl phenyl carbonate, naphthylphenyl phenyl carbonate, dinaphthyl phenyl carbonate, ditert.butylphenyl phenyl carbonate, di(di-tert.butylphenyl) carbonate, dicumylphenyl phenyl carbonate, di(dicumylphenyl) carbonate, 4-phenoxyphenyl phenyl carbonate, di(4-phenoxyphenyl) carbonate, 3-pentadecylphenyl phenyl carbonate, di(3-pentadecylphenyl) carbonate, tritylphenyl phenyl carbonate, ditrityl phenyl carbonate, 2-bis-methylsalicyl carbonate, 2-bis-ethylsalicyl carbonate

preferably

diphenyl carbonate, tert.butylphenyl phenyl carbonate, ditert.butyl phenyl carbonate, biphenyl phenyl carbonate, dibiphenyl carbonate, cumylphenyl phenyl carbonate, dicumyl phenyl carbonate,

particularly preferably diphenyl carbonate.

The diarylcarbonates may be used also containing residual amounts of the monohydroxyaryl compounds from which they have been prepared. The amounts may be up to 20%, preferably 10%, particularly preferably up to 5% and most particularly preferably up to 2%.

In addition, the phenolic compounds employed as carbonates may also be used directly as monohydroxyaryl compound in addition to one of the aforementioned carbonates, in order to influence the end groups of the polycarbonate. In this connection a monohydroxyaryl compound having its boiling point above that of the monohydroxyaryl compound from which the diaryl carbonate was formed, should be used. Preferred mixtures are those with diphenyl carbonate. In the process according to the invention it is possible to add the monohydroxyaryl compound at any point during the reaction, preferably at the start of the reaction, and the addition may be divided into several portions. The content of free monohydroxyaryl compound may be 0.4 to 17 mole %, preferably 1.3 to 8.6 mole % (referred to the dihydroxyaryl compound). In this connection the addition may take place before the reaction as well as wholly or partially during the reaction.

Referred to the dihydroxyaryl compound, the diaryl carbonates are used in an amount of 1.02 to 1.30 moles, preferably 1.04 to 1.26 moles, particularly preferably 1.06 to 1.22 moles per mole of dihydroxyaryl compound. Mixtures of the diaryl carbonates mentioned above may also be used.

As catalysts within the context of the invention there are used in the melt transesterification process basic catalysts as described in the aforementioned literature, such as for example alkali metal and alkaline earth metal hydroxides and oxides, but also ammonium or phosphonium salts, hereinafter termed onium salts. Onium salts are preferably used in this connection, phosphonium salts being particularly preferred. Phosphonium salts within the context of the invention are those of the Formula (IV)

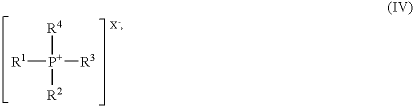

wherein

R¹⁻⁴ independently of one another denotes C₁-C₁₀-alkyls, C₆-C₁₀-aryls, C₇-C₁₀-aralkyls or C₅-C₆-cycloalkyls, preferably methyl or C₆-C₁₄-aryls, particularly preferably methyl or phenyl, and

X⁻ is an anion such as hydroxide, sulfate, hydrogen sulfate, hydrogen carbonate, carbonate, a halide, preferably chloride, or an alcoholate of the formula OR, wherein R is C₆-C₁₄-aryl or C₇-C₁₂-aralkyl, preferably phenyl.

Preferred catalysts are tetraphenylphosphonium chloride, tetraphenylphosphonium hydroxide, tetraphenylphosphonium phenolate, particularly preferably tetraphenylphosphonium phenolate.

The catalysts are preferably used in amounts of 10⁻⁸ to 10⁻³ mole, referred to one mole of bisphenol, and particularly preferably in amounts of 10⁻⁷ to 10⁻⁴ mole. Further catalysts may be used alone or optionally in addition to the onium salt, in order to increase the rate of polymerization. These include salts of alkali metals and alkaline earth metals, such as hydroxides, alkoxides and aryloxides of lithium, sodium or potassium, preferably sodium hydroxide, sodium alkoxides or sodium aryloxides. Sodium hydroxide and sodium phenolate are most particularly preferred. The amounts of the co-catalyst may be in the range from 1 to 500 ppb, preferably 5 to 300 ppb and most particularly preferably 5 to 200 ppb, in each case calculated as sodium.

The addition of the catalysts takes place in solution in order to avoid harmful excess concentrations when they are metered in. The solvents are compounds inherent to the system and process, such as for example dihydroxyaryl compounds, diaryl carbonates or monohydroxyaryl compounds. Monohydroxyaryl compounds are particularly preferred since, as is known to the person skilled in the art, the dihydroxyaryl compounds and diaryl carbonates readily alter and decompose even at slightly elevated temperatures, especially in the presence of catalysts. The compounds that are formed reduce the quality of the polycarbonate. In the technically important transesterification process for the production of polycarbonate, the preferred compound is phenol. Phenol is also particularly recommended since the preferred catalyst, i.e. tetraphenylphosphonium phenate, is isolated in the form of mixed crystals with phenol in the production.

The temperatures throughout the whole process are between 180 and 330° C., and the pressures are between 15 bar absolute and 0.01 mbar.

In the present invention there are no particular limitations however as regards pressures and temperatures needed to carry out the melt transesterification reaction between the dihydroxyaryl compound and the carbonic acid diester. All conditions are possible as long as the selected temperatures and pressures permit a melt transesterification under appropriately rapid removal of the monohydroxyaryl compound.

Also there are no limitations as regards the type of equipment in which the present invention is carried out.

Preferably the continuous process for the production of polycarbonates by transesterification of diaryl carbonates with dihydroxyaryl compounds is characterized in that, using catalysts, after a precondensation without separation of the formed monohydroxyaryl compound, an oligocarbonate is produced in a plurality of successive flash/vaporization stages with stepwise increase in temperatures and stepwise falling pressures, which is then condensed in a succession of one or more cage reactors under increasing temperatures and falling pressures to form the desired polycarbonate.

In order to carry out the process the reactants are either melted together or alternatively the solid dihydroxyaryl compound is dissolved in the diaryl carbonate melt or the solid diaryl carbonate is dissolved in the melt of the dihydroxyaryl compound, or both raw materials are combined as a melt, preferably directly from the production. The residence times of the separate melts of the raw materials, in particular the residence time of the melt of the dihydroxyaryl compound, are adjusted to be as short as possible. The melt mixture may however be subject to longer residence times without any harm on account of the reduced melting point of the raw material mixture compared to the individual raw materials, at correspondingly low temperatures. The catalyst, preferably dissolved in phenol, is then mixed in and the melt is heated to the reaction temperature. At the start of the technically important process for the production of polycarbonate from bisphenol A and diphenyl carbonate this temperature is 180 to 220° C., preferably 190 to 210° C. and most particularly preferably 190° C. The reaction equilibrium is established at residence times of 15 to 90 minutes, preferably 30 to 60 minutes, without removing the hydroxyaryl compound that is formed. The reaction may be carried out at atmospheric pressure, but for technical reasons may also be carried out at excess pressure. The preferred pressure in industrial plants is 2 to 15 bar, preferably 2 to 12 bar.

The melt mixture is flashed into a first vacuum chamber where the pressure is adjusted to 100 to 400 mbar, preferably to 150 to 300 mbar, and is then directly reheated to the inlet temperature in a suitable apparatus at the same pressure. Hydroxyaryl compound that is formed, together with monomers that are still present, are evaporated in the pressure release stage.

After a residence time of 5 to 30 minutes in a sump receiver, optionally with circulation pumping at the same pressure and same temperature, the reaction mixture is flashed into a second vacuum chamber where the pressure is 50 to 200 mbar, preferably 80 to 150 mbar, and is then directly heated in a suitable apparatus at the same pressure to a temperature of 190 to 250° C., preferably 210 to 240° C. and particularly preferably 210 to 230° C. Here too hydroxyaryl compound that is formed, together with monomers that are still present, are evaporated.

After a residence time of 5 to 30 minutes in a sump receiver, optionally with circulation pumping at the same pressure and same temperature, the reaction mixture is flashed into a third vacuum chamber where the pressure is 30 to 150 mbar, preferably 50 to 120 mbar, and is then directly heated in a suitable apparatus at the same pressure to a temperature of 220 to 280° C., preferably 240 to 270° C., and particularly preferably 240 to 260° C. Here too hydroxyaryl compound that is formed, together with monomers that are still present, are evaporated.

After a residence time of 5 to 20 minutes in a sump receiver, optionally with circulation pumping at the same pressure and same temperature, the reaction mixture is flashed into a further vacuum chamber where the pressure is 5 to 100 mbar, preferably 15 to 100 mbar, and particularly preferably 20 to 80 mbar, and is then directly heated in a suitable apparatus at the same pressure to a temperature of 250 to 300° C., preferably 260 to 290° C., and particularly preferably 260 to 280° C. Here too hydroxyaryl compound that is formed, together with monomers that are still present, are evaporated.

The number of these stages, here for example 4, may vary between 2 and 6. The relative viscosity of the oligomer achieved in these stages is between 1.04 and 1.20, preferably between 1.05 and 1.15 and particularly preferably between 1.06 and 1.10. The relative viscosity is determined as the quotient of the viscosity of the solvent and the viscosity of the polymer dissolved in this solvent. The relative viscosity was determined in dichloromethane at a concentration of 5 g/l at 25° C.

The oligomer thus produced is conveyed after a residence time of 5 to 20 minutes in a sump receiver, optionally with circulation pumping at the same pressure and same temperature as in the last flash/evaporation stage, to a cage reactor and is condensed further at 250 to 310° C., preferably 250 to 290° C. and particularly preferably 250 to 280° C., at pressures of 2 to 15 mbar, preferably 4 to 10 mbar, at residence times of 30 to 90 minutes, preferably 30 to 60 minutes. The product reaches a relative viscosity of 1.12 to 1.25, preferably 1.13 to 1.22, particularly preferably 1.13 to 1.20.

The melt leaving this reactor is adjusted in a further cage reactor to the desired final viscosity. The temperatures are 270 to 330° C., preferably 280 to 320° C., particularly preferably 280 to 310° C., the pressure is 0.01 to 3 mbar, preferably 0.2 to 2 mbar, at residence times of 60 to 180 minutes, preferably 75 to 150 minutes. The relative viscosities are adjusted to the necessary value for the intended use and are 1.18 to 1.40, preferably 1.18 to 1.36 and particularly preferably 1.18 to 1.34.

The function of the two cage reactors may also be combined in one cage reactor. The vapors are directly discharged from all process stages and may be processed for example according to German patent application no. 1 01 00 404 (e.g. column 3, sections 14-22, as well as the Examples).

The apparatus and reactors suitable for the individual process steps include, corresponding to the course of the process, heat exchangers, apparatus or stirred vessels that ensure the necessary residence time at constant temperature; pressure release apparatus as well as large-volume vessels, separators or cyclones; stirred vessels, forced circulation evaporators, falling-film evaporators or other commercially available apparatus that permits the necessary supply of heat; vessels that ensure the requisite residence times after the heating; single-shaft or twin-shaft cage or disc reactors with the necessary volumes and film-forming surfaces, as well as a construction that takes into account the increasing melt viscosities.

The pipelines between parts of the apparatus should obviously be as short as possible and the curvatures of the pipelines should be kept as small as possible. In this connection the external boundary conditions for the installation of chemical plant should be borne in mind.

For the preferred implementation of the process a conventional heat exchanger is used to heat the raw material melt. A perforated floor column is used as residence vessel to establish the reaction equilibrium. The pressure release procedures, in other words the flash vaporization, are carried out in centrifugal separators, preferably cyclones, or in baffle-plate separators. The melt flowing from the centrifugal separators, preferably cyclones, or baffle-plate separators is heated in falling-film evaporators, followed by vessels for adjusting the residence times. The vessels are provided with a pump circulation, whereby the liquids from the falling-film evaporator and the pump circulation flow through built-in grid constructions or perforated plate constructions or packed beds into the sump, where they are collected. The condensation to form a medium viscosity product is carried out in a disc or cage reactor. The polycondensation is likewise carried out in a disc or cage reactor, which under the very long residence times offers a very large, constantly renewed surface to the vacuum. The disc or cage reactors are geometrically designed corresponding to the increase in the melt viscosity. In a special arrangement one disc or cage reactor may also be sufficient. Suitable for example are reactors as described in DE 44 47 422 C2 and EP A 1 253 163, or twin-shaft reactors as described in WO A 99/28 370.

Particularly suitable materials for the production of the apparatus, reactors, pipelines, pumps and fittings are stainless steels of the type Cr Ni (Mo) 18/10, such as for example 1.4571 or 1.4541 (Stahlschlüssel 2001, Verlag: Stahlschlüssel Wegst GmbH, Th-Heuss-Straβe 36, D-71672 Marbach) and Ni-based alloys of the C type, such as for example 2.4605 or 2.4610 (Stahlschlüssel 2001, Verlag: Stahlschlüssel Wegst GmbH, Th-Heuss-Straβe 36, D-71672 Marbach). The stainless steels are employed up to process temperatures of about 290° C. and the Ni-based alloys are employed at process temperatures above about 290° C.

The thermoplastic polycarbonates obtainable by the melt transesterification process according to the invention are also covered by the present invention. They have an extremely low content of cations and anions of in each case less than 60 ppb, preferably <40 ppb and particularly preferably <20 ppb (calculated as Na cations), the cations being present as cations of alkali metal and alkaline earth metals, which may originate for example as impurities from the raw materials and phosphonium and ammonium salts that are used. Further ions such as Fe, Ni, Cr, Zn, Sn, Mo, Al ions and their homologues may be contained in the raw materials or may originate by abrasion or corrosion from the materials of the equipment that is used. The total content of these ions is less than 2 ppm, preferably less than 1 ppm and particularly preferably less than 0.5 ppm.

The smallest possible amounts that may be achieved only by using extremely pure raw materials are thus achieved. Such pure raw materials may be obtained for example only by purification processes such as recrystallization, distillation, precipitation with wash liquors, etc.

As anions, those present are anions of inorganic acids and organic acids in equivalent amounts (e.g. chloride, sulfate, carbonate, phosphate, phosphite, oxalate, etc.).

The polycarbonates are also characterized by the fact that they do not contain any detectable amounts of incorporated cleavage products or decomposition products with reactive terminal groups that are formed during the transesterification process. Such cleavage or decomposition products include for example isopropenylmonohydroxyaryl compounds or their dimers.

The mean (weight average) molecular weights that are obtained are between 15,000 and 40,000, preferably 17,000 to 36,000 and particularly preferably 17,000 to 34,000, the mean (weight average) molecular weight being determined from the relative viscosity according to the Mark-Houwing correlation (J. M. G. Cowie, Chemie und Physik der synthetischen Polymeren, Vieweg Lehrbuch, Braunschweig/Wiesbaden, 1997, p. 235).

The polycarbonates may be purposefully branched and may therefore contain minor amounts of 0.02 to 3.6 mole % (referred to the dihydroxyaryl compound) of branching agents. Suitable branching agents are the compounds with three or more functional groups that are suitable for the polycarbonate production, preferably those with three or more than three phenolic OH groups.

Some of the compounds containing three or more than three phenolic hydroxyl groups that may be used include for example:

phloroglucinol,

4,6-dimethyl-2,4,6-tri-(4-hydroxyphenyl)heptene-2,

4,6-dimethyl-2,4,6-tri-(4-hydroxyphenyl)heptane,

1,3,5-tri-(4-hydroxyphenyl)benzene,

1,1,1-tri-(4-hydroxyphenyl)ethane,

tri-(4-hydroxyphenyl)phenylmethane,

2,2-bis-[4,4-bis-(4-hydroxyphenyl)cyclohexyl]propane,

2,4-bis-(4-hydroxyphenylisopropyl)phenol,

tetra-(4-hydroxyphenyl)methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tri-(4-hydroxyphenyl)ethane.

Residual contents of monomers due to the chemical equilibrium and as a result of process parameters such as temperature, pressure and residence time may if necessary be reduced further by suitable evaporation processes.

Granules are obtained by spinning the melt by means of a gear-type pump from the reactor, cooling the strands in air or water, followed by granulation.

Functional additives and reinforcing substances may be added to the polycarbonates produced according to the invention irrespective of the production process.

The addition of additives serves to prolong the useful service life of the objects or articles produced from the polycarbonate or to improve the color (stabilizers), simplify the processing (e.g. mold release agents, flow improvers, antistatic agents) or to match the polymer properties to specific loadings/stresses (impact modifiers such as rubbers; flameproofing agents, colorants, glass fibers).

These additives may be added individually or in arbitrary mixtures or several different mixtures to the polymer melt, and more specifically directly during the isolation of the polymer or after the melting of the granules in a so-called compounding step. In this connection the additives or their mixtures may be added as a solid, i.e. as powder, or as a melt to the polymer melt. Another form of metering is the use of master batches or mixtures of master batches of the additives or additive mixtures.

Suitable additives are described for example in “Additives for Plastics Handbook, John Murphy, Elsevier, Oxford 1999”, in “Plastics Additives Handbook, Hans Zweifel, Hanser, Munich 2001”.

Suitable antioxidants and thermal stabilizers include for example:

alkylated monophenols,

alkylthiomethylphenols,

hydroquinones and alkylated hydroquinones,

tocopherols,

hydroxylated thiodiphenyl ethers,

alkylidenebisphenols,

O-, N- and S-benzyl compounds,

hydroxybenzylated malonates,

aromatic hydroxybenzyl compounds,

triazine compounds,

acylaminophenols,

esters of β-(3,5-di-tert.-butyl-4-hydroxyphenyl)propionic acid,

esters of β-(5-tert.-butyl-4-hydroxy-3-methylphenyl)propionic acid,

esters of β-(3,5-dicyclohexyl-4-hydroxyphenyl)propionic acid,

esters of 3,5-di-tert.-butyl-4-hydroxyphenylacetic acid,

amides of β-(3,5-di-tert.-butyl-4-hydroxyphenyl)propionic acid,

suitable thiosynergists,

secondary antioxidants, phosphites and phosphonites,

benzofuranones and indolinones.

Preferred are organic phosphites, phosphonates and phosphanes, generally those in which the organic radicals consist wholly or in part of optionally substituted aromatic radicals.

Ortho-phosphoric acids and meta-phosphoric acids, wholly or partially esterified phosphates or phosphites, are suitable as complexing agents for heavy metals and for neutralizing traces of alkali.

The following are suitable as light-stability agents (UV absorbers)

2-(2′-hydroxyphenyl)benzotriazoles,

2-hydroxybenzophenones,

esters of substituted and unsubstituted benzoic acids,

acrylates,

sterically hindered amines,

oxamides,

2.8. 2-(2-Hydroxyphenyl)-1,3,5-triazines,

substituted benztriazoles being preferred.

Polypropylene glycols alone or in combination with for example sulfones or sulfonamides may be used as stabilizers against damage caused by gamma radiation.

These and other stabilizers may be used individually or in combinations and added in the aforementioned forms to the polymer.

Processing auxiliaries such as mold release agents, generally derivatives of long-chain fatty acids, may also be added. For example pentaerythritol tetrastearate and glycerol monostearate are preferred. These are generally used individually or as a mixture, preferably in an amount of 0.02 to 1 wt. %, referred to the mass of the composition.

Suitable flameproofing additives include phosphate esters, i.e. triphenylphosphate, resorcinol diphosphoric acid esters, bromine-containing compounds such as brominated phosphoric acid esters, brominated oligocarbonates and polycarbonates, as well as preferably salts of fluorinated organic sulfonic acids.

Suitable impact modifiers include butadiene rubber with grafted-on styrene/acrylonitrile or methyl methacrylate, ethylene/propylene rubbers with grafted-on maleic anhydride, ethyl acrylate rubbers and butyl acrylate rubbers with grafted-on methyl methacrylate or styrene/acrylonitrile, interpenetrating siloxane and acrylate networks with grafted-on methyl methacrylate or styrene/acrylonitrile.

Colorants such as organic dyes or pigments or inorganic pigments and IR absorbers may furthermore be added individually, as a mixture or also in combination with stabilizers, glass fibers, (hollow) glass spheres or inorganic fillers.

The present invention also provides the polycarbonates that are obtained by the process according to the invention and also provides for their use for the production of extrudates and molded articles, in particular for use in transparent applications, most particularly in the area of optical applications such as for example sheets, multi-wall sheets, glazing, light-diffusing discs, lamp coverings or optical data stores such as audio CDs, CDR(W)s, DVDs, DVD-R(W)s, MiniDiscs in their various read-only or write once, possibly also completely rewriteable forms.

The extrudates and molded articles made from the polymers according to the invention are also covered by the present application.

Further applications include for example the following, without however restricting the subject matter of the present invention:

1. Safety panels, which as is known are necessary in many areas of buildings, vehicles and aircraft, as well as helmet shields.

2. Films.

3. Blow molded articles (see also U.S. Pat. No. 2,964,794), for example 1-gallon to 5-gallon water tanks.

4. Light-permeable sheets such as solid sheets or in particular hollow sheets, for example for covering buildings such as railway stations, greenhouses and lighting installations.

5. Optical data stores such as audio CDs, CD-R(W)s, DVDs, DVD-R(W)s, MiniDiscs and later generations.

6. Traffic light housings or traffic signs.

7. Foamed articles with an open or closed, optionally printable surface.

8. Threads and wires (see also DE-A 11 37 167).

9. Light technology applications, optionally using glass fibers for applications in the light transmission sector.

10. Translucent modifications containing barium sulfate and/or titanium dioxide and/or zirconium oxide or organic polymeric acrylate rubbers (EP-A 0 634 445, EP-A 0 269 324) for the production of light-permeable and light-scattering molded parts.

11. Precision injection molded parts such as mountings, e.g. lens mountings; in this connection optionally polycarbonates with glass fibers and optionally an additional content of 1 to 10 wt. % of molybdenum disulfide (referred to the total molding composition) are used.

12. Optical instrument parts, in particular lenses for camcorders and cameras (DE-A 27 01 173).

13. Light transmission carriers, in particular fiber optic cables (EP-A 0 089 801) and illumination strips.

14. Electrically insulating materials for electrical conductors and for plug housings and sockets as well as capacitors.

15. Mobile telephone housings.

16. Network interface devices.

17. Carrier materials for organic photoconductors.

18. Lamps/lights, automobile headlamps, light-diffusing panels or internal lenses.

19. Medical applications such as oxygenators and dialysis machines.

20. Foodstuffs applications such as bottles, crockery and chocolate molds.

21. Applications in the automobile sector, such as glazing, or in the form of blends with ABS, as bumpers.

22. Sports articles such as slalom poles and ski boot fastenings.

23. Household articles such as kitchen sink units, washbasins and letterbox housings.

24. Housings such as electrical distribution cabinets.

25. Housings for electrical appliances such as toothbrushes, hairdryers, coffee-making machines and machine tools such as drills, milling machines, planes and saws.

26. Washing machine portholes.

27. Protective goggles, sunglasses, optical correction glasses and their lenses.

28. Lamp coverings.

29. Packaging foils.

30. Chip containers, chip carriers and boxes for Si wafers.

31. Miscellaneous applications such as stable doors or animal cages.

The following examples are intended to illustrate the present invention without however restricting the scope of the latter.

The invention is further illustrated but is not intended to be limited by the following examples in which all parts and percentages are by weight unless otherwise specified.

### EXAMPLE

Non-destructive testing by means of the helium vacuum test on a vaporization extruder. The leak detector/helium detector (instrument from Leybold, type 200) was connected in front of the vacuum pump and the extruder, side extruder, separator, inspection windows and extrusion chambers as well as all flash connections in this region were checked. The test instrument has a response time of <5 sec. The baseline level of the apparatus was measured as <10⁻⁵ liter He×mbar/sec. The extrusion chamber was found to be gas-tight at 8×10⁻⁵ liter He×mbar/sec, whereas an inspection window was identified as a leak source with a leakage rate of 10⁻³ liter He×mbar/sec.

The relative solution viscosity was determined in dichloromethane at a concentration of 5 g/l at 25° C.

YI (Yellowness Index) was determined according to ASTM E 313 on 4 mm-thick injection molded samples. The injection molding temperature was 300° C. The color index was determined as the difference of the extinction at 420 nm and 700 nm in dichloromethane at a concentration of 2.4 g/50 ml and a layer thickness of 10 cm.

Examples showing the influence of oxygen on polycarbonate:

The following commercially available polycarbonates produced by the Bayer AG phase interface process in a plant containing apparatus with a leakage rate of <10⁻³ liter He×mbar/sec were investigated.

1. DP1-1265, a homopolycarbonate based on bisphenol A with a weight average molecular weight Mw of about 28500 and a relative viscosity η rel.=1.293−+0.5 Mw containing a few additives, which however are irrelevant in the context of this invention.

2. Makrolon 2808, a homopolycarbonate based on bisphenol A with a weight average molecular weight of about 17500 and a relative viscosity η rel.=1.197+−0.5, containing a few additives, which however are irrelevant in the context of this invention.

The samples were weighed out in air into gas-tight closed beaded rim ampoules and sealed in a gas-tight manner. These samples were then heated for 10, 20 and 30 minutes at temperatures of 320°, 350° and 380° C. After cooling the ampoules, the oxygen content in the gas space of the ampoules was determined by means of gas chromatography. The oxygen absorption of the polymer is determined from the difference with respect to the initial sample.

Samples with comparable weighed-out amounts of about 500 mg were compared. In order to estimate the limits of experimental error of the process the analyses were carried out as triple determinations. The measurements have an error range of about +/−10%. The oxygen contents, measured in vol. %, were converted into ppm or mmole/g of polymer assuming that the ideal gas law applies. The heated polymers were then dissolved and the color indices of the solutions were determined.

1^{st} Series; a commercially available, relatively low viscosity polycarbonate from Bayer AG was used for the CD productions, DP1-1265; 400 mg of polymer were weighed out and heated.

| | | |
|---|---|---|
| | Oxygen | |
| Heating Time | Absorption | Color Index |

Heating at 320° C.:

| | | |
|---|---|---|
| 10 | 810 ppm | 1.8 |
| 20 | 1050 ppm | 4.2 |
| 30 | 1345 ppm | 5.8 |

Heating at 350° C.:

| | | |
|---|---|---|
| 10 | 1070 ppm | 4.5 |
| 20 | 2260 ppm | 14.0 |
| 30 | 3270 ppm | 28.0 |

Heating at 380° C.:

| | | |
|---|---|---|
| 10 | 2540 ppm | 20 |
| 20 | 5290 ppm | 56 |
| 30 | 6710 ppm | 69 |

These experiments show that more oxygen is absorbed with increasing heating time and as a result the color index rises. The experiments also show that, with increasing temperature of the melt, significantly more oxygen is absorbed at the same residence time.

The repetition of the experiment shows that the oxygen absorption of the polycarbonate melt may readily be reproduced:

| | |
|---|---|
| | Oxygen |
| Heating Time | Absorption |

Heating at 320° C.:

| | |
|---|---|
| 10 | 760 ppm |
| 20 | 1000 ppm |
| 30 | 1390 ppm |

Heating at 350° C.:

| | |
|---|---|
| 10 | 1130 ppm |
| 20 | 2190 ppm |
| 30 | 3470 ppm |

Heating at 380° C.:

| | |
|---|---|
| 10 | 2370 ppm |
| 20 | 5120 ppm |
| 30 | 7150 ppm |

2nd Series; a commercially available polycarbonate from Bayer AG, DP1-1265, see above, was used and compared to a high molecular weight polycarbonate, Makrolon 2808, see above; 400 mg of polymer were weighed out and heated.

a) DPI-1-265, heating time 20 min:

| Heating Temperature | Oxygen Absorption | Color Index |
|---|---|---|
| 320° C. | 770 ppm | 3.3 |
| 350° C. | 2670 ppm | 16 |
| 380° C. | 5500 ppm | 50 |

b) Makrolon 2808, heating time 20 min:

| Heating | Oxygen | |
|---|---|---|
| Temperature | Absorption | Color Index |
| 320° C. | 640 ppm | 6.3 |
| 350° C. | 2270 ppm | 26.0 |
| 380° C. | 5160 ppm | — |

The values obtained here show that a good reproduction in DP1-1265 is obtained once more. It may also be seen that in the case of the higher viscosity M 2808, although the melt tends to absorb somewhat less oxygen the damage as measured by the color index is however significantly increased.

Further examples, polycarbonates produced by the melt transesterification process:

1. FS 20 SO natur is a linear polycarbonate with a relative solution viscosity of 1.201 and a color index of 0.11. The phenolic OH value is 540 ppm.

2. FS 26 SO natur is a linear polycarbonate with a relative solution viscosity of 1.275 and a color index of 0.14. The phenolic OH value is 250 ppm.

These products obtained from the apparatus as described before and according to the invention have an excellent quality. A leakage rate of >10⁻³ liter He×mbar/sec in the apparatus according to the invention would lead to a contamination of the polycarbonate melt with oxygen. In this case a reduced quality of the products should be expected. This is demonstrated by the characterization of the oxygen absorption and CO₂ cleavage of industrially produced melt polycarbonate under temperature as a function of the heating time:

The samples described above were investigated: FS 20 SO and FS 26 SO

The samples were heated for 10, 20 and 30 minutes at temperatures of 320°, 350° and 380° C. under an air atmosphere in gas-tight, beaded rim ampoules. The oxygen and CO₂ content in the gas space of the ampoules was then determined by means of gas chromatography.

Samples containing comparable weighed-out amounts of about 500 mg were compared. In order to estimate the limits of experimental error of the process the analyses were carried out as triple determinations. The measurements have an error range of about +/10%.

The oxygen and CO₂ contents, measured in vol. %, were converted into ppm and mmole/g of polymer assuming that the ideal gas law applies.

| | | | | |
|---|---|---|---|---|
| Temperature/° C. | t min | ppm O₂ | ppm CO₂ | Color Index |

FS20S0

| | | | | | |
|---|---|---|---|---|---|
| | 320 | 10 | 775 | 550 | 1.5 |
| | | 20 | 1156 | 1075 | 4.8 |
| | | 30 | 1330 | 1350 | 7.5 |
| | 350 | 10 | 1290 | 1330 | 5.8 |
| x | | 20 | 2895 | 2870 | 25 |
| x | | 30 | 3900 | 4478 | 38 |
| x | 380 | 10 | 2924 | 3360 | 27 |
| x | | 20 | 5683 | 6899 | 44 |
| x | | 30 | 7662 | 10581 | 48 |

FS26S0

| | | | | | |
|---|---|---|---|---|---|
| | 320 | 10 | 531 | 197 | 1.5 |
| | | 20 | 711 | 541 | 3.4 |
| | | 30 | 971 | 797 | 5.2 |
| | 350 | 10 | 933 | 699 | 4.1 |
| x | | 20 | 1973 | 1986 | 16 |
| x | | 30 | 3215 | 3362 | 32 |
| x | 380 | 10 | 2409 | 2404 | 16 |
| x | | 20 | 4508 | 4884 | 44 |
| x | | 30 | 6711 | 8064 | 37 |

The samples identified by “x” contained insoluble/darkish brown particles, which may influence the results obtained with these samples making these results not as precise than others.

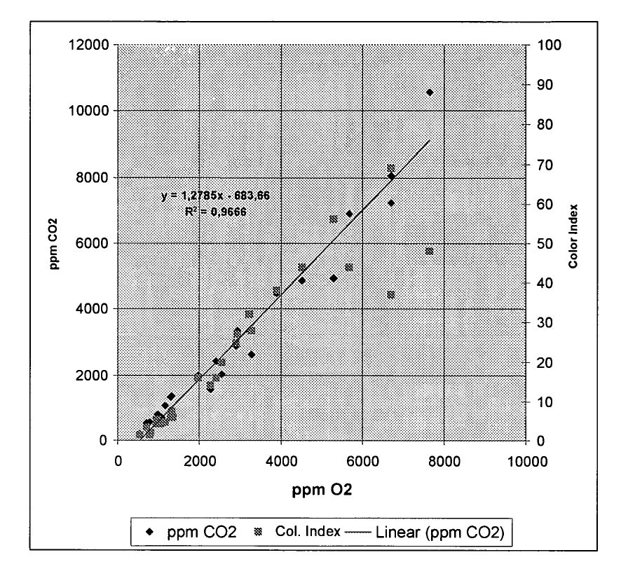

The relationship between the color index and the CO₂ cleavage (ppm) as a function of the O₂ absorption (ppm) is illustrated in FIG. 1.

It may be seen from FIG. 1 that up to O₂ absorptions of about 6000 ppm there is to a good approximation a linear relationship between the color index and CO₂ cleavage as a function of the oxygen absorption. The results of the investigated polycarbonates are summarized in FIG. 1.

The example clearly demonstrates the harmful influence of air and oxygen at elevated temperatures and average residence times on the color quality of the melt polycarbonate.

Surprisingly, such an influence with all its negative effects may be prevented by the process according to the invention, which requires the use of apparatus having a defined hermeticity, without the need for large apparatus expenditure with inert gas metering equipment or the like.

Overall the experiments show that the exposure of the polycarbonate melt to oxygen should be kept as low as possible. Surprisingly it is possible by means of the simple process according to the invention to achieve a low exposure of the polycarbonate melt.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of polycarbonate using equipment having leakage rate less than 10⁻³ liter He×mbar/sec.

2. The polycarbonate prepared by the process according to claim 1.

3. A molded article comprising the polycarbonate of claim 2.

4. An extrudate comprising the polycarbonate of claim 2.

5. An optical data storage medium comprising the polycarbonate according to claim 2.

6. A process for the production of a molded polycarbonate article comprising using equipment having leakage rate that is less than 10⁻³ liter He×mbar/sec.

7. The molded article prepared by the process of claim 6.

8. An process for the production of an extruded article comprising using equipment having leakage rate that is less than 10⁻³ liter He×mbar/sec.

9. The extruded article prepared by the process of claim 8.

10. A process for determining a leakage rate in an apparatus comprising connecting a helium detector to the vapor lines of the apparatus, flushing all potential leaks with helium from a gas lance, and measuring the leakage using a detector.
